(19) United States
(12) Patent Application Publication
(10) Pub. No.: US 2026/0230378 A1
(43) Pub. Date: Aug. 6, 2026

(54) ATTENTION-ENHANCED CLOUD SERVICE MONITOR CONFIGURATION SYSTEM

(71) Applicant: Microsoft Technology Licensing, LLC, Redmond, WA (US)

(72) Inventors: Fiza HUSAIN, Rohini (IN); Saravanakumar RAJMOHAN, Redmond, WA (US); Rujia WANG, Chicago, IL (US); Chetan BANSAL, Seattle, WA (US); Anjaly PARAYIL, Babusapalya (IN); Ayush CHOURE, Bengaluru (IN)

(21) Appl. No.: 19/047,216

(22) Filed: Feb. 6, 2025

(51) Int. Cl. H04L 41/0681; H04L 41/16; H04L 43/16

(52) U.S. Cl. CPC H04L 41/0681; H04L 41/16; H04L 43/16

(57) ABSTRACT

A system and method for configuring cloud service monitors using an attention-enhanced graph neural network (GNN) are presented. The system constructs an input graph representing relationships between entities such as monitors, metrics, and dimensions. The GNN employs multi-head attention mechanisms to focus on relevant node relationships. A scoring mechanism evaluates enriched node representations, generating predicted probability scores for potential configuration relationships. Link prediction is used to determine valid configurations, resulting in tailored recommendations for cloud service monitors. The model incorporates a composite loss function, including diversity and ranking losses. By leveraging service dependency and reliability data, the system provides context-aware configuration recommendations, enabling the monitoring capabilities of cloud services.

### TECHNICAL FIELD

Embodiments pertain to cloud computing technologies, specifically to systems and methods for configuring cloud service monitors using attention-enhanced graph neural networks.

### BACKGROUND

Cloud service providers depend on continuous oversight to ensure high availability and reliability. Automated systems analyze telemetry data emitted by services to generate alerts and warnings. However, the current process of creating and configuring these systems is often ad-hoc and reactive, relying on developers' informal knowledge and trial-and-error methods. This approach can lead to incomplete coverage, resulting in delayed incident detection, poor service quality, and customer dissatisfaction. Additionally, the complexity of configuring such systems, which involves setting numerous attributes, poses significant challenges for developers who may not fully understand the implications of the configurations.

Existing solutions in cloud monitoring typically focus on refining alert mechanisms or assume predefined metrics and dimensions for alerting conditions. These approaches often lack comprehensive methods for recommending specific configuration settings tailored to the distinct properties of a particular cloud service. As a result, a more systematic and effective approach to configuration is desired that can provide accurate and comprehensive recommendations, thereby enhancing service quality and reducing the risk of redundant or ineffective system.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a summary of the model according to some embodiments.

FIG. 2 illustrates model inference according to some embodiments.

FIG. 3 illustrates model training according to some embodiments.

FIG. 4 illustrates a block diagram of an example electronic device according to some embodiments.

FIGS. 5A-5C show characteristics of a monitor entity graph according to some embodiments.

FIG. 6A shows the Jaccard similarity of a set of dimensions associated with monitors with similar metric, monitor names, and same service account according to some embodiments; FIG. 6B shows the distribution of pairwise correlation between dimensions according to some embodiments.

FIG. 7 shows an overall architecture of the attention-enhanced graph neural network framework according to some embodiments.

FIGS. 8A and 8B show the impact of ranking and diversity loss on model performance.

### DETAILED DESCRIPTION

As above, cloud service providers maintain high levels of availability and reliability only by continuously monitoring their services, that is continuously recording information about their health in the form of run-time telemetry. Monitors are the automated watchdogs that continuously analyze the telemetry emitted by services to detect anomalies and create alerts and warnings based thereon. Each service emits multiple metrics (time-series data) along different dimensions. Examples of these dimensions include indicators such as the success of an operation, file path, environment of service deployment, and the identifier of a compute node. The monitors aggregate the metrics emitted along various dimensions, and the alerting conditions operate on the aggregated signal to create an alert. Based on the nature of the monitor, only a subset of the dimensions may be used for aggregating the signal. Any gaps in monitoring can lead to delayed incident detection and significant negative customer impact.

Unfortunately, the current process of monitor creation is ad-hoc and reactive in nature. Developers rely solely on tribal knowledge and a trial-and-error process to create monitors. Moreover, the process of monitor creation is extremely complex, requiring developers to configure numerous attributes for the monitors, many of which they may not understand completely and are unsure of their effects. To compensate, developers often look to similar monitors to set these values. This process often results in incomplete monitor coverage, leading to production ring issues, poor service quality, customer dissatisfaction, and redundant monitors that generate noise and waste resources. Furthermore, the intricacy of the entire process makes it difficult for developers to maintain the monitors they created or locate a specific monitor.

To address the technical problems involved in monitor creation and configuration, including configuring expressions and alerts, a technical solution providing a framework is described that builds similarity models using configurations from existing monitors and generates new configurations for monitors of interest for a given service. The framework can be implemented as an attention-enhanced entity ranking model designed to tackle the monitor configuration problem. This technical solution uses different attributes of monitors to construct a graphical network, which in turn is fed into the monitor configuration framework that helps enhance the capabilities of cloud service monitors by providing accurate and comprehensive configuration recommendations. The framework is an attention-enhanced entity ranking model designed to tackle the monitor configuration problem. This approach enhances the capabilities of cloud service monitors by providing accurate and comprehensive configuration recommendations.

In particular, the system automates the complex and traditionally manual process of configuring cloud service monitors by leveraging a graph neural network (GNN)-based approach. By constructing a graphical network from various attributes of existing monitors and feeding the data into the GNN framework, the system can generate new configurations for monitors of interest. This not only addresses issues involved in determining the configurations to be used for a cloud service but also demonstrates substantial performance gains, such as a 39.7% increase in Mean Reciprocal Rank (MRR), displaying superior performance over existing methods.

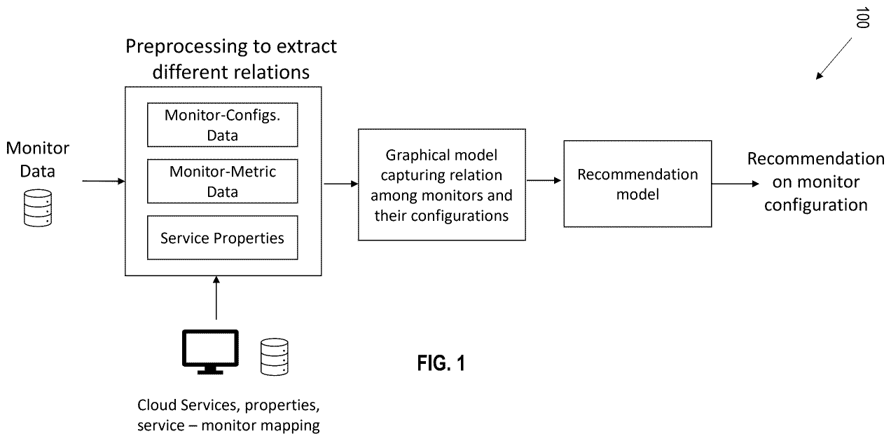

FIG. 1 illustrates a summary of the model according to some embodiments. The model receives data that is to be monitored and eventually provides a recommendation for a monitor configuration. The monitor has multiple associated components, such as metrics, which are series of measured values collected and stored over time, dimensions, which define the level at which metrics are collected and stored, and alert conditions which define the expressions to be evaluated and the thresholds to be used to initiate an alert. The metrics provide understanding the performance and health of cloud services. The dimensions provide context to the metrics, such as the environment or region where the data is collected. The alert conditions are used for determining when a particular metric or set of metrics indicates an issue that toward which attention is to be directed.

The data is pre-processed to extract different relations from the input data to construct a graphical model that captures the relationships among cloud service monitors and their configurations. This preprocessing permits an input graph to be established. The input graph is processed by the GNN as described in more detail below. The preprocessing operations include data collection, entity identification, relationship extraction, and graph construction. The data collection gathers data related to cloud service monitors, including metrics, dimensions, and alert conditions. This data forms the basis for constructing the input graph. The different entities involved in the monitoring process are identified and categorized. These entities include cloud service monitors, metrics, and dimensions. The relationships between the entities are extracted to form the edges of the graph. The relationships include Monitor-to-Dimension Associations that identify which dimensions are associated with each cloud service monitor for aggregating metrics, Metric-to-Dimension Connections that determine the connections between metrics and the dimensions along which the dimensions are emitted, and Monitor-to-Metric Connections establish the relationship between the cloud service monitors and the metrics tracked by the cloud service monitors. The identified entities and extracted relationships are used to construct a heterogeneous graph. This graph serves as the input for the GNN, representing the complex interactions and dependencies between the various components of the cloud service monitoring system.

As shown in FIG. 1, the monitor-configurations data refers to the specific settings and parameters associated with cloud service monitors. This data includes the various attributes and configurations that define how a cloud service monitor operates and what the cloud service tracks. Components of the monitor-configurations data include monitor name, metrics, dimensions, alert conditions, and configuration settings. The monitor name is the identifier or name of the cloud service monitor, which may reflect the specific function or service with which the cloud service monitor is associated. The metrics are, as above, the performance indicators that the monitor tracks, such as CPU usage, memory usage, transaction rates, and latency. The metrics provide quantitative measurements of the cloud service performance. The dimensions are topological components that define the levels at which metrics are collected and stored. Examples of the dimensions include data center location, environment (e.g., production, staging), and region. The alert conditions are the criteria and thresholds that determine when an alert should be triggered based on the monitored metrics. In addition to the expressions used to evaluate the metrics, the alert conditions include and the specific threshold values that, when breached, generate an alert. The configuration settings are various settings that define how the monitor operates, such as the frequency of data collection, the look-back period for aggregating metrics, the severity of alerts, and the aggregation methods (e.g., average, median).

The monitor-metric data refers to the information related to the metrics that are tracked by cloud service monitors. The monitor-metric data include the metrics, the metric-to-dimension connections, (i.e., the number of metrics to which each dimension is connected) and the monitor-to-metric connections (i.e., the number of monitors to which each metric is connected). The metric-to-dimension connections help in understanding how metrics are aggregated and analyzed in different contexts, such as specific environments or regions. The Monitor-to-Metric connections relationship is used for determining which metrics are relevant for a particular cloud service monitor and how the metrics should be configured.

Service properties and service dependencies are interrelated aspects that provide a comprehensive understanding of how cloud services operate and interact within a cloud infrastructure. The service properties refer to the attributes and characteristics of cloud services that are relevant for configuring and monitoring these services. These properties provide context for understanding how a cloud service operates and what aspects are to be monitored. The service properties may include service name, service type, operational environment, geographical location, service dependencies, performance metrics, Service Level Agreements (SLAs), and configuration settings. The service name is the identifier or name of the cloud service, which may reflect the specific function or service with which the cloud service is associated. The service type is the category or classification of the cloud service, such as compute, storage, database, or networking. The operational environment is the environment in which the cloud service operates, such as production, staging, or development. The geographical location is the physical or virtual location where the cloud service is hosted, which can impact latency and data residency requirements. The service dependencies are the relationships and interdependencies between the cloud service and other cloud services or components within the cloud infrastructure. The performance metrics are key performance indicators specific to the cloud service, such as response time, throughput, and error rates. The SLAs provide expected performance and availability standards for the cloud service, which may include uptime guarantees and response time commitments. The configuration settings are specific settings that define how the cloud service operates, such as resource allocation, scaling policies, and security configurations.

Service dependencies indicate the relationships and interdependencies between different services (and/or components) in a cloud-based environment where one service relies on another to function correctly. The service dependencies can be direct, indirect, or hierarchical. Direct dependencies occur when one service relies directly on another service to perform its operations. For example, a web application service might depend on a database service to store and retrieve data. Indirect Dependencies occur when a service relies on another service, which in turn depends on a third service. For example, a web application might depend on an authentication service, which in turn depends on a user directory service. Hierarchical Dependencies represent a layered structure where higher-level services depend on lower-level services. For example, a business logic service might depend on data access services, which in turn depend on storage services.

The service dependencies also include service chaining, service mesh, redundancy and failover, SLAs, and dependency mapping. Service chaining involves a sequence of service calls where the output of one service becomes the input for another. For example, a user request might pass through an API gateway, authentication service, business logic service, and finally a data service. A service mesh is a dedicated infrastructure layer that manages service-to-service communication. The service mesh provides features like load balancing, service discovery, and failure recovery, which are used for managing service dependencies. To ensure high availability, services often have redundant dependencies; thus, if one instance of a dependent service fails, another instance can take over to maintain continuity. Dependencies also often come with SLAs that define the expected performance and availability of the dependent services. For example, a database service may guarantee a certain response time and uptime percentage. Dependency mapping involves creating a visual or logical map of all the dependencies between services. Dependency mapping helps in understanding the impact of changes or failures in one service on other dependent services.

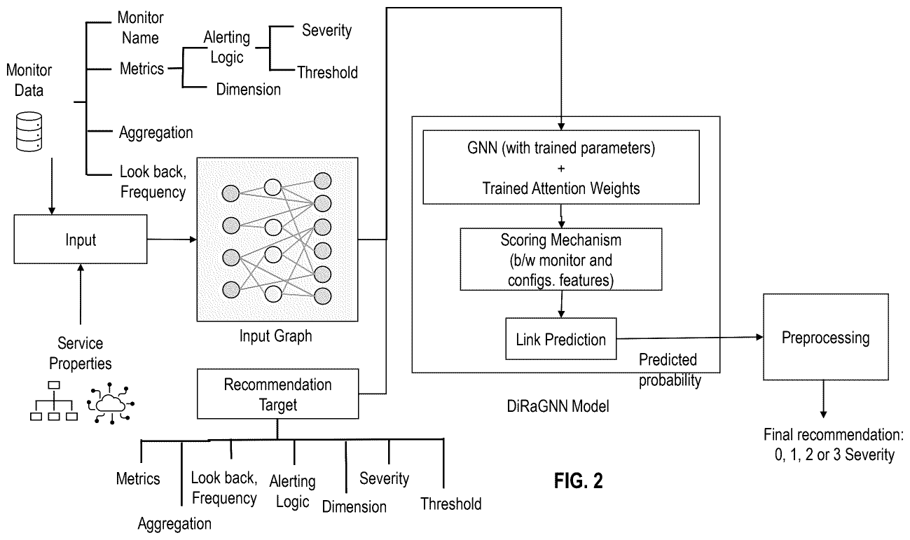

FIG. 2 illustrates model inference according to some embodiments. The inference mode occurs after the GNN has been trained and is the process by which the Diverse Ranking for Graph Neural Networks (DiRaGNN) model utilizes the trained GNN to generate configuration recommendations for cloud service monitors. The DiRaGNN is also referred to herein as an attention-enhanced graph neural network.

As shown, the process begins with the input of data related to cloud service monitors, including metrics, dimensions, and alert conditions. This data is used to construct an input graph that represents the relationships between various entities, such as monitors, metrics, and dimensions. The input graph serves as the foundational data structure for the inference process.

Similarity models are built using configurations from existing monitors of other cloud-based services. These models identify and analyze similarities between the cloud-based service for which a monitor is to be generated and other cloud-based services (or entities). The similarity models help in understanding which configurations from existing monitors are relevant and can be used as a reference for the new monitor. Similarity models begin by collecting data from existing monitors, including their configurations, metrics, dimensions, and alert conditions. The models extract relevant features from this data, such as performance metrics, operational environments, and service dependencies, to create a comprehensive profile of each monitor. Using these features, the models perform a similarity analysis to identify patterns and commonalities between the cloud-based service for which a monitor is to be generated and other cloud-based services. This analysis may involve techniques such as cosine similarity, Jaccard similarity, or other distance metrics. The models determine which configurations from existing monitors are most relevant and can serve as references for the new monitor. This helps in leveraging proven configurations to optimize the setup of new monitors. The input graph is constructed using the data and relationships identified by the similarity models.

The GNN processes the input graph (and thus the similarities identified by the similarity models) to learn the complex relationships and interactions between the nodes (representing monitors, metrics, and dimensions) and edges (representing their associations). The GNN employs multiple layers of message passing and aggregation to generate enriched node representations. These representations incorporate information from neighboring nodes and the overall graph structure, capturing the intricate dependencies within the cloud service environment. The GNN thus creates a graphical network that represents the relationships between different attributes of the monitors and processes the graphical network to generate configuration recommendations for the new monitor.

In particular, the nodes represent various entities associated with cloud service monitors. Specifically, the nodes include monitor nodes representing cloud service monitors that are configured to track the performance and health of cloud services. Each monitor node includes attributes such as the monitor name, alert conditions, thresholds, severity levels, and aggregation settings. The nodes also include metrics nodes that represent the time-series data that provide quantitative measurements of various performance indicators of the cloud services. Examples of metrics include CPU usage, memory usage, transaction rates, and latency. The nodes also include dimension nodes that represent the topological components of the cloud services that define the levels at which metrics are collected and stored. Examples of dimensions include data center location, environment (e.g., production, staging), region, and specific identifiers like compute node IDs.

The relationships between the nodes are captured by the edges, which represent monitor-to-dimension associations, metric-to-dimension connections, and monitor-to-metric connections. These monitor-to-dimension edges indicate the association between a monitor and the dimensions the monitor uses to aggregate metrics. The metric-to-dimension connections edges represent the connections between metrics and the dimensions along which the metrics are emitted. The monitor-to-metric connections edges indicate the relationship between a monitor and the metrics the monitor tracks.

Within the DiRaGNN model, an attention mechanism calculates attention weights that determine the importance of different neighboring nodes and their relationships. These weights allow the model to focus on the most relevant parts of the input graph, enhancing the ability to capture significant interactions and dependencies and forming enriched nodes using aggregation. The enriched node representations thus incorporate information from the node's neighbors and the overall structure of the graph.

The enriched node representations are evaluated by a scoring mechanism in the DiRaGNN model that analyzes similarities between monitors and services. The scoring mechanism weights relationships according to shared characteristics and dependencies, applying the trained attention weights to generate predicted probability scores for potential configuration relationships.

Using the predicted probability scores, a link prediction component in the DiRaGNN model evaluates potential configuration relationships against known configuration patterns. The link prediction component determines the likelihood of valid configuration relationships and generates recommendations based on the highest probability relationships. This ensures that the most effective configurations are identified.

The final output of the DiRaGNN model inference process is a set of recommended configurations for cloud service monitors. These recommendations include metrics to monitor (identifying which performance indicators (e.g., CPU usage, memory usage) should be tracked), dimensions for aggregation (determining the topological components (e.g., data center location, environment) to be used for aggregating the metrics), alert conditions and thresholds (specifying the criteria and thresholds for triggering alerts based on the monitored metrics), and configuration settings (defining how the monitor operates, including the frequency of data collection, look-back period, severity of alerts, and aggregation methods). The recommendations are tailored to the specific needs and characteristics of the cloud service environment, enhancing the monitoring capabilities of cloud services. The attention-weighted rankings are used to determine the relative importance of different relationships between monitors, metrics, and dimensions. These rankings help prioritize the most relevant and impactful configurations provided by the GNN.

The DiRaGNN model is thus a framework that incorporates the GNN, attention mechanisms, scoring, and link prediction components to generate configuration recommendations.

The data provided to the GNN includes telemetry and dependency and reliability data of cloud services. Telemetry of cloud services refers to the automated collection, transmission, and analysis of data that provides insights into the performance, health, and usage of cloud-based applications and infrastructure. This data is used for monitoring, diagnosing, and optimizing cloud services, the telemetry includes metrics (e.g., CPU usage, memory usage, disk input/output that indicates a rate of read and write operations, network traffic that indicates an amount of data being transmitted and received over a network, transaction rates that indicates a number of operations processed per unit time, and latency that indicates a time taken to process an operation), logs that contain records of events and activities that occur within the cloud service, including information about errors, warnings, informational messages, and user activities, traces that track flow of requests through various components of the cloud service, events that include specific occurrences or incidents that are significant for operation of the cloud service and include system failures, configuration changes, and security breaches, alerts that are generated based on predefined thresholds, and health indicators that provide a snapshot of overall health of the cloud service and that include uptime, error rates, and service availability. Telemetry data is collected continuously and can be analyzed in real-time or stored for historical analysis. This data is used for monitoring the cloud service's performance and detecting anomalies or issues, diagnostics to investigate and troubleshoot problems when the problems occur, identifying areas for improvement and optimizing resource usage, and ensuring that the cloud service meets regulatory and security requirements.

Service dependency data is used to enhance the configuration recommendations for cloud service monitors. By understanding the dependencies between services, the GNN can determine which services are critical for the operation of other services and prioritize their monitoring, assess the potential impact of a failure in one service on other dependent services and configure monitors accordingly, generate more accurate and comprehensive configuration recommendations by considering the interdependencies and usage patterns between services, and ensure that monitors are configured to detect issues in dependent services early, thereby improving the overall reliability and availability of the cloud infrastructure.

Service reliability data refers to information that quantifies and describes the dependability and consistent performance of a cloud service. This data allows the GNN to understand how well a service meets its expected performance and availability standards over time. The service reliability data includes uptime, downtime, mean time between failures (MTBF), mean time to repair (MTTR), failure rate, error rate, response time, throughput, redundancy and failover mechanisms, SLAs, incident reports, and historical performance data. The uptime is the amount of time a service is operational and available to users. Uptime is typically expressed as a percentage of total time, such as 99.9% uptime, which indicates high reliability. The downtime is the amount of time a service is unavailable or non-operational. Downtime can be planned (e.g., for maintenance) or unplanned (e.g., due to failures). The MTBF is the average time between successive failures of a service; a higher MTBF indicates greater reliability. The MTTR is the average time taken to repair a service after a failure; a lower MTTR indicates quicker recovery and higher reliability. The failure rate is the frequency at which a service fails over a specified period. This can be measured in failures per hour, day, or month. The error rates are the frequency of errors occurring within the service, such as failed transactions, incorrect responses, or system crashes. The SLAs may include metrics like uptime, response time, and error rates. The response time is the time taken by a service to respond to a request; consistently low response times indicate high reliability. The throughput is the number of transactions or operations a service can handle within a given time frame; high throughput indicates the service can reliably handle high loads. The incident reports are records of incidents that have affected the service's reliability, including details about the cause, impact, and resolution of each incident. The redundancy and failover mechanisms are information about the redundancy and failover strategies implemented to ensure service continuity in case of failures. The historical performance data is the historical records of the service's performance over time, including trends and patterns that can indicate potential reliability issues.

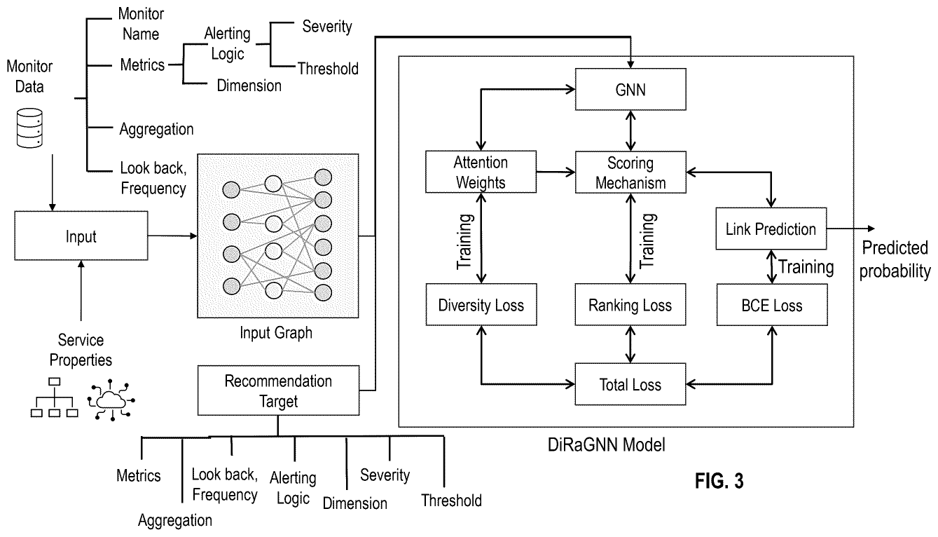

FIG. 3 illustrates model training according to some embodiments. Training the GNN involves several steps to ensure that the model learns to generate accurate and effective configuration recommendations for cloud service monitors. The steps include data preparation, configuration training, and loss functions.

To prepare the data, the input graph is constructed using cloud service monitor data and service properties data. The graph, as above, includes nodes representing cloud service monitors, metrics, and dimensions, and edges representing monitor-to-dimension associations, metric-to-dimension connections, and monitor-to-metric connections.

The input graph is supplied to the GNN; embeddings, convolution layers, and transformer layers are used within the GNN to process the input graph. Feature embeddings for monitors and dimensions are generated using a language model, such as the “E5” embedding model. These embeddings capture semantic and relational information of the entities from textual descriptions of metrics and dimensions. The embeddings are generated for each node in the graph, allowing the model to learn and utilize the contextual relationships between different entities. The convolution layers in the are used to aggregate information from a node's local neighborhood. This process helps in learning the structural and relational patterns within the graph. The convolution layers apply a learnable aggregation function to combine the features of a node with those of its neighbors. This aggregation process is repeated across multiple layers, allowing the model to capture increasingly complex interactions and dependencies within the graph. Transformer Layers, particularly the attention mechanisms within the transformer layers, are used to focus on different aspects of node relationships simultaneously. This allows the model to capture long-range dependencies and complex interactions within the graph. The transformer layers incorporate multi-head attention mechanisms, which compute attention scores for different neighboring nodes and their relationships. These scores are used to weight the importance of each neighbor, enabling the model to focus on the most relevant parts of the graph.

The training configuration includes message passing layers that the GNN uses to propagate information through the graph. Each layer aggregates information from neighboring nodes to update the node representations. The GNN is also configured with a specific number of hidden channels and output channels to control the dimensionality of the node representations. In some examples, an Adam (Adaptive Moment Estimation) optimizer is used with a predetermined learning rate and weight decay to update the model parameters during training. A learning rate scheduler is employed to reduce the learning rate if the validation loss does not improve for a predetermined number of consecutive epochs. The GNN implements early stopping to prevent overfitting by halting training if the validation loss does not improve for a specified number of epochs. The training process uses a predetermined batch size to control the number of samples processed in each training iteration.

The Adam optimizer is an optimization algorithm used in training machine learning models, particularly neural networks. It is designed to efficiently handle sparse gradients and noisy data, making it well-suited for a wide range of applications. The Adam optimizer computes individual adaptive learning rates for each parameter by maintaining separate learning rates for each weight in the model. This allows the optimizer to adjust the learning rate dynamically based on the historical gradient information. The Adam optimizer incorporates the concept of momentum by using moving averages of the gradients and the squared gradients. This helps in smoothing out the updates and can lead to faster convergence. The Adam optimizer includes bias correction terms to account for the initialization of the moving averages, ensuring that the estimates are unbiased, especially during the initial stages of training. The Adam optimizer is computationally efficient and requires little memory, making it suitable for large-scale and high-dimensional data. The Adam optimizer has a few hyperparameters, such as the learning rate, and two decay rates for the moving averages, which can be tuned to improve performance.

Both positive and negative samples are used in each iteration during the training of the GNN. The positive samples are actual relationships between entities in the input graph, such as valid monitor-to-dimension associations, metric-to-dimension connections, and monitor-to-metric connections. Positive samples represent the correct configurations and interactions that the GNN should learn to recognize and reinforce. The negative samples are generated relationships that do not exist in the actual data. Negative samples are used to help the model learn to distinguish between valid and invalid configurations. They are typically generated at a predetermined ratio of negative to positive cases, often using on-the-fly negative sampling during training. By training on both positive and negative samples, the GNN learns to accurately predict valid configuration relationships and generate effective recommendations.

During training, the DiRaGNN model uses multiple loss functions as shown in FIG. 3. These loss functions include Binary Cross-Entropy (BCE) loss, ranking loss, and diversity loss functions. The BCE loss function measures the difference between predicted probabilities and actual labels, ensuring basic prediction accuracy. The BCE loss function thus interacts with the link prediction mechanism. The ranking loss function optimizes the order of recommendations by encouraging the model to score positive connections higher than negative ones. The ranking loss function acts as a regularizer and improves the model's ability to distinguish between more and less relevant entities. The ranking loss function interacts with the scoring mechanism. The diversity loss function encourages the model to capture varied aspects of the data by penalizing similar attention patterns across different attention heads. This promotes a more comprehensive representation of the graph structure. The diversity loss function interacts with the attention weights. The loss functions used during the training of the GNN help optimize the model's performance by encouraging diverse attention patterns, optimizing the order of recommendations, and ensuring basic prediction accuracy. The individual loss functions are integrated within a total loss function, which represents the combined loss function that guides the training of the GNN.

The GNN uses multi-head attention determiners to enhance the model's ability to focus on different aspects of node relationships simultaneously. They are inspired by the multi-head attention mechanism used in transformer architectures. The multi-head attention determiners use a multi-head attention mechanism that involves multiple attention heads, each of which learns to focus on different parts of the input data. By having multiple heads, the model can capture various types of relationships and interactions between nodes in the graph. Each head computes attention scores independently and then the results are combined to form the final output. Attention weights are calculated for each attention head to determine the importance of different neighboring nodes and their relationships. These weights are used to aggregate information from the neighbors, allowing the model to focus on the most relevant parts of the graph. The multi-head attention determiners aggregate the information from multiple attention heads in a deterministic manner. This means that the aggregation process is consistent and repeatable, ensuring that the model can reliably capture and utilize the different aspects of node relationships.

Each attention head operates independently and in parallel to focus on different parts of the input data, capturing various aspects of the relationships between nodes. Each attention head operates using query, key, and value vectors. The query vector represents the current node or the node for which the attention is being calculated, the key vector represents the neighboring nodes or the nodes to which the attention is being directed, and the value vector represents the actual information or features of the neighboring nodes.

The attention head calculates the attention score for each neighboring node by taking the dot product of the query vector and the key vector of the neighboring node. The attention score is then scaled by the square root of the dimension of the key vectors to ensure stable gradients during training. The attention scores are passed through a softmax function to normalize the attention scores. This ensures that the attention scores sum to 1 and can be interpreted as probabilities. The attention head uses the normalized attention scores to compute a weighted sum of the value vectors of the neighboring nodes.

The outputs of all attention heads are concatenated and linearly transformed to produce the final output. The concatenated output from all attention heads is passed through a linear transformation to combine the information from different heads. This combined output is then used as the input for subsequent layers or for making predictions.

The attention heads use deterministic aggregation to provide a consistent and repeatable process of combining information from multiple sources or nodes in a graph. Deterministic aggregation ensures that the way information is aggregated from neighboring nodes is predictable and does not vary randomly. This maintains the reliability and stability of the model's outputs.

The aggregation process follows a fixed set of rules or operations that do not change between different runs or instances. This means that given the same input, the aggregation always produces the same output. Common deterministic aggregation functions include mean, sum, and max pooling. These functions combine the features or information from neighboring nodes in a consistent manner in which mean aggregation computes the average of the features from neighboring nodes, sum aggregation computes the sum of the features from neighboring nodes, and max aggregation selects the maximum value from the features of neighboring nodes.

The training process includes edge set division, in which the edge set is divided into training, validation, and test sets. The training set includes edges used for message passing and fewer edges used for supervision. Fixed negative edges are generated at a predetermined ratio for evaluation, and dynamic negative edges are generated during training using on-the-fly sampling. To manage computational complexity, the GNN uses a multi-hop subgraph sampling method. This approach allows the model to consider both immediate and more distant relationships, capturing complex interactions in the cloud monitoring system. As above, the GNN is trained using positive examples (actual relationships between entities) and negative examples (generated at a predetermined ratio of negative to positive cases). This helps the model learn correct relationships between monitors, metrics, and dimensions.

The model is evaluated using metrics such as Hit Ratio (HR@k), Mean Reciprocal Rank (MRR), Normalized Discounted Cumulative Gain (NDCG@k), and Recall@k. These metrics assess the accuracy, ranking quality, and retrieval effectiveness.

After training the DiRaGNN model, the model may be used in the inference mode to provide recommended monitor configurations. The user can use the DiRaGNN model to automatically set up a monitor configuration, or the configuration may be provided to the user for approval, after which the code may be automatically generated to implement the monitor,

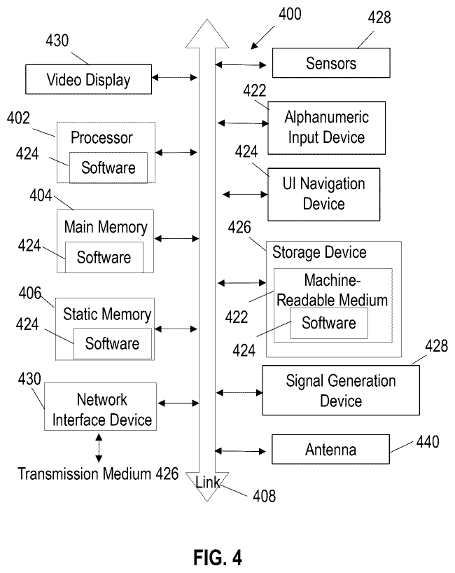

FIG. 4 illustrates a block diagram of an example electronic device, according to some embodiments. The electronic device 400 may operate as a standalone device or may be connected (e.g., networked) to other devices and may use the structure and framework described herein. The electronic device 400 may be a cloud-based device as described herein. The electronic device 400 may have additional components not shown in FIG. 4 and/or some of the components shown in FIG. 4 may not be present.

The electronic device 400 may include a hardware processor 402 (e.g., a central processing unit (CPU), a graphics processing unit (GPU), a hardware processor core, or any combination thereof), a main memory 404, and a static memory 406, some or all of which may communicate with each other via an interlink (e.g., bus) 408.

Specific examples of main memory 404 include Random Access Memory (RAM), and semiconductor memory devices, which may include, in some embodiments, storage locations in semiconductors such as registers. Specific examples of static memory 406 include non-volatile memory, such as semiconductor memory devices (e.g., Electrically Programmable Read-Only Memory (EPROM), Electrically Erasable Programmable Read-Only Memory (EEPROM)) and flash memory devices.

The electronic device 400 may further include a display device 410, an input device 412 (e.g., a keyboard), and a user interface (UI) navigation device 414 (e.g., a mouse). In an example, the display device 410, the input device 412, and the UI navigation device 414 may be a touch screen display. The electronic device 400 may additionally include a storage device (e.g., drive unit) 416, a signal generation device 418 (e.g., a speaker), a network interface device 420, one or more antennas 430, and one or more sensors 428, such as a global positioning system (GPS) sensor, compass, accelerometer, or other sensors. The electronic device 400 may include a transmission medium 426, such as a serial bus (e.g., universal serial bus (USB)), parallel, or other wired or wireless (e.g., infrared (IR), near field communication (NFC), etc.) connection to communicate or control one or more peripheral devices (e.g., a printer, card reader, television). In some embodiments, the hardware processor 402 and/or instructions 424 may comprise processing circuitry and/or transceiver circuitry.

The storage device 416 may include a machine-readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or the hardware processor 402 during execution thereof by the electronic device 400. In an example, one or any combination of the hardware processor 402, the main memory 404, the static memory 406, or the storage device 416 may constitute machine-readable media.

While the machine-readable medium 422 is illustrated as a single medium, the term “machine-readable medium” may include a single medium or multiple media (e.g., a centralized or distributed database, and/or associated caches and servers) configured to store instructions 424. The term “machine-readable medium” may include any medium that is capable of storing, encoding, or carrying instructions for execution by electronic device 400 and that causes the electronic device 400 to perform any one or more of the techniques of the present disclosure, or that is capable of storing, encoding or carrying data structures used by or associated with such instructions. Non-limiting machine-readable medium examples may include solid-state memories and optical and magnetic media. Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

The instructions 424 may further be transmitted or received over a communications network using a transmission medium 426 via the network interface device 420 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, 3GPP family of standards including Long Term Evolution (LTE) and 4G/5G/6G standards, a Universal Mobile Telecommunications System (UMTS) family of standards, peer-to-peer (P2P) networks, among others.

In an example, the network interface device 420 may include one or more physical jacks (e.g., Ethernet, coaxial, or phone jacks) or one or more antennas to connect to the communications network. In an example, the network interface device 420 may include one or more antennas 430 to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques. The term “transmission medium” shall be taken to include any intangible medium that can carry instructions for execution by the electronic device 400, which include digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to ROM, RAM, magnetic disk storage media, optical storage media, flash memory, etc.

The hardware processor 402 may use various circuitry to send and receive communication via the antennas 430. Although not exclusive, such circuitry may include mixers (such as up- and down-conversion mixer circuitry configured to convert signals between baseband and the transmission frequency), amplifiers configured to amplify signals for communication, filters configured to filter out spurious signals, and drivers to drive the antennas 430.

As above, the DiRaGNN model is a representation learning framework enhanced with transformer-style graph convolutions. The convolutions incorporate multi-head attention mechanisms, enabling the model to capture complex, long-range dependencies in the graph structure. The edge-aware message passing ensures that the message is sensitive to specific relationship types. The framework incorporates a diversity-aware loss function, which aggregates and attends to various information from different nodes and their interaction patterns. Unlike baseline approaches, the DiRaGNN model employs a multi-faceted loss function to prioritize relevant recommendations and effectively attend to different node contexts. The diversity loss penalizes similar attention patterns across different heads and learns a comprehensive graph structure, while the ranking loss improves the model's ability to distinguish between more and less relevant entities. Experiments on the monitor-entity dataset show significant improvements in the hit-rate, mean reciprocal rank, and recall over baselines.

The cloud monitoring framework includes the structural properties of the monitor, which encompass the resource upon which the monitor is created (e.g., CPU), the metric being monitored (e.g., processor time), the time series data used to raise alerts, and dimensions such as region and environment of service deployment.

There are several approaches to predict metrics to be monitored for a given cloud service. However, given the metric, mi and the set of dimensions along which the metric is already being emitted, the problem of ranking dimensions along which the metric is to be aggregated to raise an alert is explored herein. Furthermore, the monitor entity graph containing monitors, metrics, and dimensions is a heavy-tailed sparse graph, with limited interaction between most of the monitors, metrics, and dimensions. The sparsity is further exacerbated by the fact that most of the dimensions along which a metric is emitted are not used during monitor creation. As a result, the framework herein focuses on developing a solution to the problem of recommending dimensions for monitor creation in the context of this heavy-tailed sparse graph. To start, the monitor entities and their various interactions, as well as their textual node attributes, are modeled as a heterogeneous multi-type interaction graph. From this graph, effective node representations are generated, which are then used for dimension ranking. The monitor entity graph and related attributes are also defined.

Definition 1. (Monitor Entity Graph): the data is represented as a heterogeneous graph G=(V, E) where V={Vₘ∪V_{d}∪Vₖ} represents the set of nodes with Vₘ, V_{d}, Vₖ denoting monitors, dimensions, and metrics, respectively and E={E_{md}∪E_{kd}∪Eₘₖ} represents the set of edges, capturing three types of relationships: 1) E_{md}: “monitor associated with dimension”, 2) E_{kd}: “metric has dimension”, and 3) Eₘₖ: “monitor emits metric”.

The graph structure G captures the intricate relationships in the data that are used for making informed recommendations. By explicitly modeling different entity types and their relationships, the model is enabled to learn domain-specific patterns. Each node in the graph, denoted as v∈V, has a unique initial representation given by xᵥ∈R^{d}, where d is the dimension of the embedding space. The vector xᵥ is the concatenation of two types of features: intrinsic features, which are domain-specific attributes of the entity (e.g., metric name, dimension name, monitor name, related service), and learned embeddings, which are trainable embeddings that capture the entity's role in the graph structure (e.g., co-occurrence with another node). The monitor entity graph is assumed to be a static graph.

The problem of ranking dimensions for monitor creation in the monitor-entity graph, G with different types of node features and link features is defined as follows:

Problem (Dimension Ranking using Heterogeneous Interactions). Leverage entity features {xᵥ:v∈V}, link features {eᵥ_{₁}ᵥ_{₂}∈E} and monitor entity graph, G, to generate entity representations that facilitate relevant recommendations.

### Definition of Heterogeneous Graph and Notations

GNNs learn node representations by propagating features from local graph neighborhoods via trainable neighbor aggregators. In this context, the basic notations and formulations that are useful during message passing in GNN frameworks are introduced. GNNs use multiple layers to learn node representations. At each layer l>0 (where l=0 is the input layer), GNNs compute a representation for node vi by aggregating features from its neighborhood through a learnable aggregator F_{θ,l} per layer. The embedding for node v₁ at the l-th layer is given by:

$${h}_{{v}_{1} , 1} = {F}_{θ , 1} ( {h}_{{v}_{1} , 1 - 1} \{ {h}_{{v}_{2} , l - 1} \} ) , {v}_{2} ∈ N ( {v}_{1} ) \qquad ( 1 )$$

The embedding hᵥ_{₁}_{,l} at the l-th layer is a non-linear aggregation of its embedding hᵥ_{₁}_{,l-1} from layer l−1 and the embedding of its immediate neighbors v₁∈N(v). The function F_{θ,l} defines the message-passing function at layer l and can be instantiated using a variety of aggregators. The node representation for vi at the input layer is h_{v,0}, where h_{v,0}=xᵥ∈R^{D}.

### Attention Enhanced Entity Ranking for Sparse GNNs

The analysis of the monitor entity graph and insights into the structure of the network, as well as the features that impact node relationships are discussed. The insights are used to inform the framework design for dimension recommendations and ranking.

### Monitor Entity Graph: Qualitative Analysis

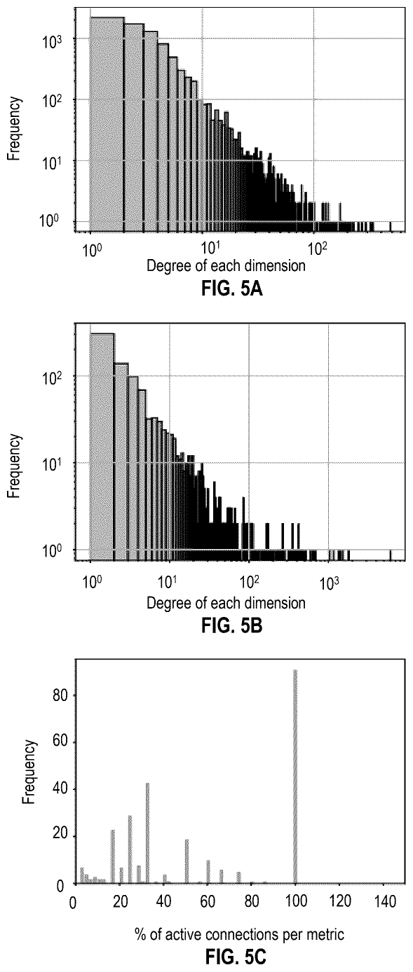

FIGS. 5A-5C illustrates the characteristics of the monitor entity graph. FIG. 5A shows the distribution of degree associated with dimensions based on the metric-to-dimension links (i.e., the number of metrics to which each dimension is connected). FIG. 5B shows the distribution of dimension degree based on the monitor-to-dimension interactions from the monitor entity graph. The likelihood test ratio indicates a resemblance to long-tailed distributions. Next, the distribution of the percentage of dimensions selected from the set of all dimensions along which the metric is emitted is analyzed. As seen in FIG. 5C, the distribution is skewed to the left, indicating that the majority of monitors may not aggregate the metrics along all dimensions along which they are emitted. As shown, the “monitor entity” graph faces activity sparsity. Although many dimensions are associated with metrics, only a subset of the dimensions is used to aggregate the metric while raising an alert.

Next, the features associated with the nodes are analyzed to understand its impact on recommendations. The analysis starts with the text features associated with the monitor entity graph and its effect on dimensions associated with the monitors. FIG. 5A shows the distribution of Jaccard similarity between sets of dimensions associated with monitors that exhibit high cosine similarity (>0.8) between different text features. The text similarity in the monitor names, metric names, and the service account associated with the monitor are considered. The feature embeddings are generated using the “E5” embedding model, a general-purpose model trained through contrastive learning. The Jaccard similarity of dimensions from monitors exhibits different trends with respect to the similarity in the metric, monitor names, and that from the same service account. Furthermore, the similarity in dimensions with similar monitor names shows higher variance.

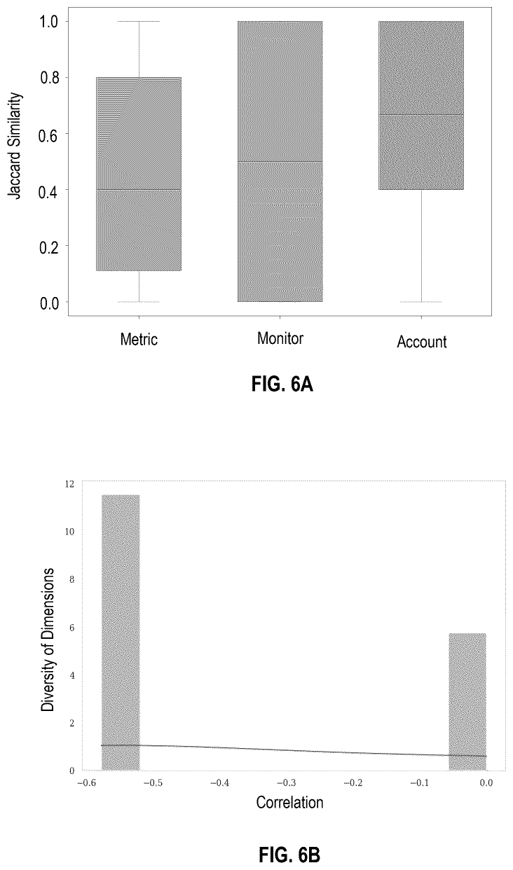

FIG. 6A shows the variation in Jaccard similarity of set of dimensions associated with monitors with similar metric, monitor names, and same service account. FIG. 6B shows the density of pairwise correlation between dimensions connected to a monitor. The correlation plot shows two peaks signifying the presence of distinct groups with different trends. As seen in FIG. 6B, the majority of dimension pairs are negatively correlated, indicating the absence of a specific dimension in the presence of another.

A significant overlap was observed in the dimensions used by monitors associated with the same service account, those with similar metrics, and those with similar names. However, the extent of similarity varies across the features. Further, the correlation between dimension pairs shows the presence of two distinct groups, where some dimensions are negatively correlated, while the other group is not correlated. Specifically, the framework for representing entities of a node should consider the varying degrees of similarity across different features and the distinct correlation patterns among dimension pairs.

### DiRaGNN for Diverse Ranking of Recommendations

The DIRAGNN framework is presented to encode the multifaceted nature of cloud monitoring data and generate node representation for different entities. The graph representation, G captures both the inherent properties of each entity and its context within the graph structure. The domain-specific attributes provide an inductive bias based on domain knowledge, while the learned embeddings allow the model to discover latent relationships and characteristics. The use of domain-specific attributes enables the model to generalize to new entities not seen during training which is useful in dynamic cloud environments.

### Message Passing Mechanism

The framework employs an effective message passing mechanism designed to capture complex relationships and contextual information. The multi-head attention enhanced message passing approach leverages edge-specific transformations and heterogeneous neighborhood aggregation. The key components of the message passing mechanism are:

Multi-Head Attention. A multi-head attention mechanism to allow the model to focus on different aspects of node relationships simultaneously. This permits the relevance of different neighbors and relationship types in the graph to be distinguished. The attention weights α are computed as

$${a}_{i j} = \frac{( {q}_{i} \cdot {k}_{k} )}{\sqrt{{d}_{h} {d}_{o}}} ,$$

where qᵢ is the query vector for node i, kⱼ is the key vector for node j, dₕ is the number of attention heads, and dₒ is the output dimension per head. The attention weights are then normalized using softmax:

$${a}_{i j} = \frac{exp ( {a}_{i j} )}{{\sum }_{k ∈ 𝒩 ( i )} exp ( {a}_{i j} )}$$

where [symbol] (i) is the set of neighbors of node i.

Edge-Aware Message Transformation. The message passing considers the type of relationship between the nodes. The transformed message incorporates both the node features and the computed attention weights, ensuring that the message is sensitive to the specific relationship type. The transformed message mᵢⱼ from node j to node i is computed as mᵢⱼ=αᵢⱼvⱼ, where vⱼ is the value vector of node j. The final aggregated message for node i is mᵢ=

[symbol]

mᵢⱼ. The node features are updated as: xᵢ^{(l+1)}=σ(W^{(l)}·CONCAT (xᵢ^{(l)},mᵢ^{(l)})), where xᵢ^{(l)} is the feature vector of node i at layer l, W^{(l)} is the learnable weight matrix for layer l, s is the ReLU activation function, and CONCAT is the concatenation operation.

By using attention mechanisms, the importance of different types of relationships and neighbors can be dynamically assigned. The multi-head attention allows the model to leverage limited interactions more effectively, mitigating the impact of sparse data. After multiple rounds of message passing, each monitor node has an enriched representation incorporating information from relevant dimensions and metrics. These representations are used to score potential monitor-dimension pairs.

### Training Objective

In recommendations systems, the choice of training objective directly influences the model's ability to make accurate, well-ranked, and diverse recommendations. A composite loss function is defined that addresses multiple aspects of the recommendation task simultaneously. The loss function combines three components: 1) Binary Cross-Entropy Loss, 2) TOP1-max Ranking Loss, and 3) Diversity Loss.

Binary Cross-Entropy Loss: The binary cross-entropy loss is fundamental for our basic prediction accuracy which is defined as:

$${ℒ}_{B C E} = - \frac{1}{N} {\sum }_{i = 1}^{N} [ {y}_{i} log ( \hat{{y}_{ι}} ) + ( 1 - {y}_{i} ) log ( 1 - \hat{{y}_{ι}} ) ] \qquad ( 2 )$$

where yᵢ is the true label and y\hat{ }ᵢ is the predicted probability. The BCE loss ensures basic prediction accuracy.

TOP1-max Ranking Loss: To optimize the order of recommendations, the TOP1-max ranking loss is used. This loss aims to push the target score above the scores of negative samples while also acting as a regularizer. It is defined as:

$${ℒ}_{TOP 1 - max} = {\sum }_{j = 1}^{N} {s}_{j} [ σ ( {r}_{j} - {r}_{i} ) + σ ( {r}_{j}^{2} ) ] \qquad ( 3 )$$

where rᵢ is the score for the positive sample, rⱼ are scores for negative samples, sⱼ=softmax (rⱼ), and σ is the sigmoid function. The first term of the TOP1-max ranking loss encourages the positive score to be higher than the maximum negative score and the second term acts as a regularizer, pushing negative scores towards zero. This loss optimizes the order of recommendations, crucial for top-k recommendation scenarios.

Diversity Loss: To encourage the model to capture diverse aspects of the graph structure, a diversity loss component is introduced. The diversity loss [symbol] is computed as:

$${ℒ}_{d i v} = {λ}_{d i v} \cdot \frac{1}{L} {\sum }_{l = I}^{L} M S E ( {α}_{l} , {\overline{α}}_{l} ) \qquad ( 4 )$$

where αₗ are the attention weights in layer l, α̅ₗ is their mean, and λ_{div} is the diversity strength. This diversity loss penalizes similar attention patterns across different heads, promoting a more comprehensive representation of the graph structure. It prevents the model from over-focusing on a few popular items, particularly important in sparse data settings.

The final loss function combines all the above components.

$${ℒ}_{t otal} = {ℒ}_{B C E} + {ℒ}_{TOP 1 - max} + {ℒ}_{d i v} \qquad ( 5 )$$

Dynamic Loss Balancing: To ensure optimal contribution from each loss component, a dynamic loss balancing mechanism is used that adjusts the weights of different loss components during training, allowing for adaptive optimization of our multi-objective function.

Neighborhood Sampling and Subgraph Generation. In large-scale heterogeneous graphs, processing the entire graph for each recommendation task can be computationally expensive. Moreover, distant nodes in the graph may introduce noise rather than providing useful information. These challenges are addressed by focusing on the most relevant parts of the graph and employing a multi-stage approach to neighborhood sampling and subgraph generation:

A carefully designed edge splitting strategy is used for training, validation, and testing, balancing between information propagation and model supervision. During training, negative edges are generated on-the-fly which helps in efficient learning of edge distinction.

To capture relevant neighborhood context, a multi-hop sub-graph sampling method is used. This approach allows the model to consider both immediate and more distant relationships, which allows for understanding the complex interactions in cloud monitoring systems.

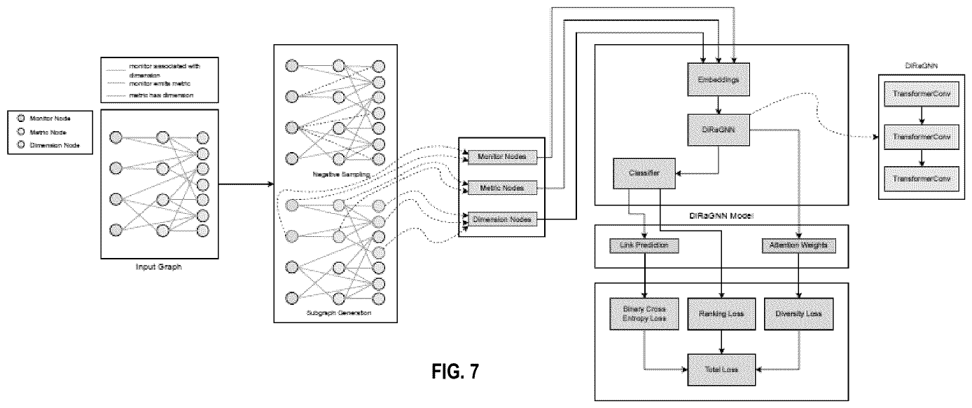

The multi-hop sampling strategy, combined with dynamic negative sampling during training, allows the model to explore a broader range of graph structures while focusing on the most informative negative examples. This also enables the model to effectively learn from sparse interaction graphs, capturing complex relationship between monitors, dimensions, and metrics, while maintaining computational feasibility. FIG. 7 provides an overall architecture of the attention-enhanced graph neural network framework according to some embodiments.

To evaluate the effectiveness of the framework, a series of experiments were conducted on the task of dimension recommendation for monitors in cloud environments. The experimental setup, evaluation metrics, baseline comparisons, and results analysis are provided below.

### Experiment Setup

### Datasets

The experiments utilize a heterogeneous graph dataset representing a complex cloud monitoring system. The dataset comprises of three types of entities (nodes) and three types of relationships (edges). It captures the intricate interactions between monitors, dimensions, and metrics in a cloud environment. The main statistics of the dataset are summarized in Table 1. This graph structure effectively represents the complex relationships in cloud monitoring systems, where monitors are associated with specific dimensions and emit various metrics, while metrics themselves are characterized by multiple dimensions.

TABLE 1
Dataset

| Dataset | Node | Edge |
|---|---|---|
| Cloud | # monitors: 18291 | # monitor, associated with, |
| Monitoring | # metrics: 4623 | dimension: 52148 |
| System | # dimensions: 8356 | # metric, has, dimension: 109213 |
| | | # monitor, emits, metric: 52148 |

Feature Representation: To capture the semantic information of monitors and dimensions, feature embeddings generated using a state-of-the-art language model were employed: 1) Monitor Features: Represented by the embeddings of the metric names associated with each monitor (each monitor is associated with a single metric), and 2) Dimension Features: Represented by the embedding of the dimensions names.

Both feature embeddings are generated using the “E5” embedding model, a general-purpose model trained through contrastive learning. This approach allowed capture of rich semantic information from the textual descriptions of metrics and dimensions, enabling the model to understand and utilize the contextual relationships between different entities in the cloud monitoring system.

### Training Details

The DiRaGNN model was trained train using L=3 message passing layers with hidden channels size of 256 and output channels size of 128. The Adam optimizer was used with a learning rate of 0.001 and weight decay of 10⁻⁵. To adapt the learning rate during training, a learning rate scheduler which reduces the learning rate by half if the validation loss does not improve for 5 consecutive epochs was employed. The training ran for a maximum of 100 epochs, with early stopping implemented to prevent over-fitting. A patience of 10 epochs was used for early stopping. The edge set was divided into training (80%), validation (10%), and test (10%) sets. Within the training set, 70% of edges were used for message passing, and 30% for supervision. For evaluation, fixed negative edges with a ratio of 2:1 (negative to positive) were generated. During training, negative edges were dynamically generated using on-the-fly negative sampling. Multiple hops from both ends of a link were generated to create subgraphs. A negative sampling ratio of 2.0 was used during training. A batch size of 128 was used for training.

### Evaluation Metrics

Hit Ratio (HR@k): Measures the percentage of test cases where the correct dimension is in the top k recommendations.

Mean Reciprocal Rank (MRR): The average of the reciprocal rank of the first correct dimension in the recommendations.

Normalized Discounted Cumulative Gain (NDCG@k): Measures the ranking quality of the recommendations, with k set to the number of true dimensions for each monitor.

Recall@k: The proportion of true dimensions that are successfully retrieved in the top k recommendations.

### Baselines

THE model was compared against the following baselines:

SAGEConv+Mean: GraphSAGE with mean aggregation. Element-wise mean pooling for neighbor aggregation and self-embedding concatenation at each layer.

SAGEConv+Max: GraphSAGE with max pooling aggregation. Element-wise max pooling for neighbor aggregation and self-embedding concatenation at each layer.

TranformerConv: The graph transformer operator. A multi-layer Graph Transformer network takes the input to perform attentive information propagation between nodes. For message aggregation, the framework concatenates information across all the heads.

The model was evaluated in two configurations:

Diversity Loss: the model featuring a custom TransformerConv with multi-head attention and integrated layer-wise diversity loss.

DiRaGNN: Diverity Loss+Ranking Loss: the complete model featuring a custom TransformerConv with integrated layer-wise diversity loss and ranking optimization.

TABLE 2
Results

| Metric | HR@1 | HR@3 | HR@5 | MRR | N@k | R@1 | R@3 | R@5 |
|---|---|---|---|---|---|---|---|---|
| SAGEConv + | 0.383 | 0.186 | 0.127 | 0.499 | 0.328 | 0.218 | 0.379 | 0.474 |
| Mean | | | | | | | | |
| SAGEConv + | 0.291 | 0.154 | 0.111 | 0.414 | 0.262 | 0.165 | 0.323 | 0.398 |
| Mean | | | | | | | | |
| TransformerConv | 0.331 | 0.188 | 0.134 | 0.481 | 0.306 | 0.178 | 0.399 | 0.523 |
| TransformerConv + | 0.547 | 0.238 | 0.157 | 0.650 | 0.500 | 0.210 | 0.561 | 0.655 |
| Diversity Loss | | | | | | | | |
| DiRaGNN | 0.573 | 0.246 | 0.159 | 0.672 | 0.525 | 0.342 | 0.592 | 0.675 |

As shown, the DiRaGNN framework outperforms SAGEConv using mean and max aggregation and TransformerConv. The framework demonstrates relative gains of 49.6%, 60.1%, and 29.06% in Hit-Rate@1, NDCG@k, and Recall@5 respectively with respect to the best baseline.

### Results

Both variants of the model significantly outperform the baselines across all metrics. The full model with both diversity and ranking losses shows the best overall performance. The full model achieves HR@1 of 0.573, which is a 49.6% improvement over the best baseline (SAGEConv+Mean at 0.383), indicates a substantial enhancement in the ability to recommend the most relevant dimension as the top choice. The NDCG@k score of 0.525 for the full model, compared to 0.328 for the best baseline, represents a 60.1% improvement. The results suggests that the model not only recommends relevant dimensions but also ranks them more effectively. The model shows significant improvements in Recall@k, particularly at higher k values. The Recall@5 of 0.675 for the full model compared to 0.523 for TransformerConv indicates a 29.06% improvement in retrieving relevant dimensions within the top 5 recommendations. The introduction of diversity loss alone leads to substantial improvements across all metrics compared to the baselines. This underscores the importance of encouraging diverse attention patterns in the model. The addition of ranking loss to diversity loss results in further improvements, particularly in HR@1 and MRR. This highlights the effectiveness of the multi-faceted loss function in optimizing both accuracy and ranking quality.

The intuition behind the improved performance of the proposed framework is discussed below:

DiRaGNN uses a multi-head attention mechanism, which allows it to capture the relative importance of different neighbor types more effectively than “SAGEConv”, which relies on mean or max aggregation. On the other hand, while “TransformerConv” uses attention, it may struggle to distinguish between different types of relationships as effectively as DiRaGNN.

The diversity loss in the framework encourages it to capture varied aspects of the data, whereas the baselines do not have an explicit mechanism to encourage diversity in their representations.

The ranking loss from DiRaGNN directly optimizes for ranking quality. In contrast, the baselines are typically trained with binary classification objectives, which may not directly optimize for ranking quality.

Baselines may struggle with sparsity more than the framework, as they rely more heavily on dense connection patterns.

### Ablation Study

To understand the individual contributions of the model components, an ablation study focusing on the diversity loss and ranking loss was conducted. Three model variants were compared: 1) Base model (without diversity and ranking loss), 2) Model with only ranking loss, and 3) Model with only diversity loss. The changes in the ranks of the recommended dimensions across different monitors and the performance of these variants were aggregated using rank stability plots, which visualize change in the relevance of top ranked dimensions across different model configurations.

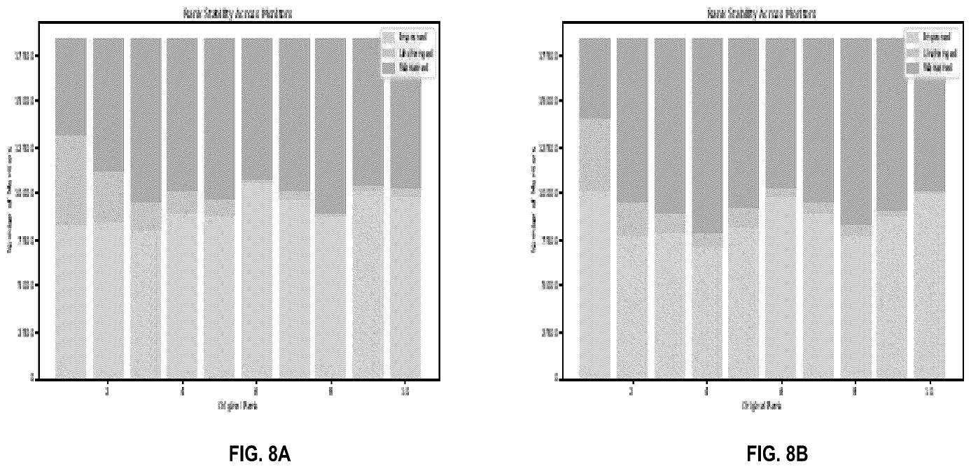

FIGS. 8A and 8B show the impact of ranking and diversity loss on model performance. FIG. 8A shows the impact of ranking on model performance, and FIG. 8B shows the impact of diversity loss on model. The overall quality of recommended dimensions improved with the addition of the ranking loss and diversity loss.

Impact of ranking on model performance: the results in FIG. 8A show a significant improvement in ranking performance across all positions: 1) Top-ranked items (Rank 1) demonstrate high stability, with a large proportion remaining unchanged, 2) Lower-ranked items (Ranks 2-10) show substantial improvements, with the proportion of improved rankings increasing for initially lower-ranked items, and 3) Very few rankings worsen, especially in the lower ranks, indicating that the ranking loss effectively optimizes the order of recommendations. The ranking loss is particularly effective at improving the position of dimensions initially ranked lower (Ranks 8-10), suggesting that it helps in surfacing relevant but previously undervalued dimensions.

Impact of diversity loss on model performance: the results in FIG. 8B show the effect of incorporating only the diversity loss into the base model. While also improving overall performance, it exhibits a different pattern compared to the ranking loss: 1) As compared to the impact of the ranking loss, improvements are more uniformly distributed, indicating a more uniform impact on the entire ranking, and 2) There is slightly less stability for top-ranked items compared to the ranking loss model.

The diversity loss encourages a broader exploration of the dimensional space, promoting a wider range of dimensions across different rank positions. Both losses contribute positively to the model's performance, but with distinct characteristics. The ranking loss is useful for optimizing the order of recommendations, particularly beneficial for surfacing relevant dimensions from lower ranks. The diversity loss contributes to a more balanced improvement across all ranks, enhancing the model's ability to recommend a varied set of relevant items. Both losses combined provide a synergistic effect: the ranking loss optimizes the overall order, while the diversity loss ensures a broader range of relevant dimensions to be considered.

These findings support the decision to incorporate both ranking and diversity losses in the final model. The ranking loss ensures high-quality ordered recommendations, while the diversity loss helps prevent over-focusing on a narrow set of popular items—a factor in sparse interaction graphs typical in cloud monitoring systems.

### EXAMPLES

Example 1 is a system for configuring network-based service monitors, comprising: a processor; and a memory storing instructions that, when executed by the processor, cause the system to: identify an input graph comprising: nodes representing network-based service monitors that continuously analyze telemetry emitted by network-based services to detect anomalies and create alerts and warnings based thereon, metrics that identify which performance indicators should be tracked, and dimensions that are used for aggregation of the metrics and that define metric collection levels of the network-based services at which the metrics are collected and stored, and edges indicating associations between the network-based service monitors and the dimensions, connections between the metrics and the dimensions, and relationships between the network-based service monitors and the metrics; generate a recommended monitor configuration for a particular network-based service by processing the input graph through an attention-enhanced graph neural network trained using existing monitor-to-dimension associations, metric-to-dimension connections, and monitor-to-metric connections from other network-based service monitors; process, using a graph neural network of the attention-enhanced graph neural network, the input graph to produce enriched node representations for each node of the input graph, the enriched node representation for each node incorporating information from neighbors of the node and an overall structure of the input graph; evaluate, using a scoring mechanism of the attention-enhanced graph neural network, the enriched node representations by analyzing monitor and service similarities, weighting relationships according to shared characteristics and dependencies, and applying trained attention weights to generate predicted probability scores for potential configuration relationships indicating a likelihood of valid and effective configurations; evaluate, using a link prediction component of the attention-enhanced graph neural network, the predicted probability scores against known configuration patterns to determine a likelihood of valid configuration relationships to generate the recommended monitor configuration based on probability relationships among the valid configuration relationships; and configure a network-based service monitor for the particular network-based service based on the recommended monitor configuration.

In Example 2, the subject matter of Example 1 includes, wherein the recommended monitor configuration comprises: metrics to monitor for the particular network-based service, dimensions for the particular network-based service, alert conditions and thresholds associated with the aggregation of the metrics for the particular network-based service that specify criteria and thresholds for triggering alerts based on the monitored metrics, and configuration settings for the network-based service monitor that define a manner in which the network-based service monitor operates, including a frequency of data collection, look-back period, severity of alerts, and aggregation methods.

In Example 3, the subject matter of Examples 1-2 includes, wherein the attention-enhanced graph neural network further comprises attention-weighted rankings that determine relative importance of different relationships between the network-based service monitors, metrics, and dimensions to prioritize potential configurations for the network-based service monitor.

In Example 4, the subject matter of Examples 1-3 includes, wherein: the instructions, when executed by the processor, cause the system to: receive network-based service monitor data of the network-based service monitors that comprises the metrics, dimensions, and monitor configurations; and receive service properties data for the network-based services monitored by the network-based service monitors, the service properties data comprising service dependency data indicating dependencies among the network-based services, service reliability data that describes dependability of performance of the network-based services, and service-to-service similarity data indicating overlapping dependencies and usage patterns between the network-based services; and identifying the input graph comprises creating the input graph from network-based service monitor data and service properties data.

In Example 5, the subject matter of Examples 1~4 includes, wherein the graph neural network comprises: multi-head attention determiners configured to determine different aspects of node relationships within the graph neural network; edge-aware message transformers that determine specific relationship types among the node relationships; and a composite loss function configured to combine binary cross-entropy, ranking optimization, and diversity components within the graph neural network.

In Example 6, the subject matter of Example 5 includes, wherein: the multi-head attention determiners comprise multiple attention heads, each attention head is configured to: focus on different parts of data input to the graph neural network, compute attention scores independently, and combine the attention scores to form a final output, and for each attention head, attention weights are calculated to determine an importance of different neighboring nodes and relationships among the neighboring nodes, the attention weights used to aggregate information from the neighboring nodes for the graph neural network to focus on most relevant parts of the graph neural network.

In Example 7, the subject matter of Example 6 includes, wherein the different parts of input data include: time-series data of the metrics, the time-series data representing performance indicators of a cloud-based service, the time-series data including at least one of: CPU usage, memory usage, disk input/output, network traffic, transaction rates, and latency; the dimensions, which include at least one of data center location, environment, region, and compute node IDs, alert conditions, which include criteria and thresholds that determine when an alert should be triggered based on monitored metrics, the alert conditions including expressions used to evaluate the metrics and threshold values that, when breached, generate an alert, configuration settings, which define a manner in which the network-based service monitor operates including at least one of frequency of data collection, look-back period for aggregating metrics, severity of alerts, and aggregation methods, and relationships between attributes, which include connections and interactions between different attributes of the network-based service monitors, including an association between each network-based service monitor and its metrics, a connection between the metrics and dimensions for the network-based service monitor, and relationships between different monitors.

In Example 8, the subject matter of Example 7 includes, wherein: each attention head is configured to: calculate an attention score for each neighboring node by taking a dot product of a query vector (Q) and a key vector (K) of the neighboring node, the query vector representing a current node for which attention is being calculated, the key vector representing neighboring nodes to which the attention is being directed, a value vector representing features of the neighboring nodes, scale the attention score by the square root of a dimension of key vectors, normalize the attention scores using a softmax function, and compute a weighted sum of value vectors of the neighboring nodes using the normalized attention scores, the attention heads are configured to operate in parallel, concatenated output from the attention heads is passed through a linear transformation to combine the concatenated output, and the combined output is used for making predictions.

In Example 9, the subject matter of Examples 1-8 includes, wherein the dimensions represent indicators of a cloud-based services that include success of an operation, file path, environment deployment of the cloud-based services, and identifier of a compute node.

In Example 10, the subject matter of Examples 1-9 includes, wherein aggregation of the metrics uses a subset of all dimensions that emitted by the metrics.

In Example 11, the subject matter of Examples 1-10 includes, wherein the graph neural network includes: a training configuration that uses message passing layers, hidden and output channels, an Adam optimizer with a predetermined learning rate and weight decay, a learning rate scheduler configured to reduce a learning rate in response to determining that a validation loss fails to improve for a predetermined number of consecutive epochs, a maximum number of epochs with early stopping to halt training if the validation loss does not improve for a specified number of epochs, and a predetermined batch size, and an edge set divided into a training set, a validation set, and a test set, in which: the training set includes edges used for message passing and fewer edges used for supervision, fixed negative edges are generated at a predetermined ratio for evaluation, and dynamic negate edges are generated during training using on-the-fly sampling, and loss component functions include: binary cross-entropy loss that measures a difference between predicted probabilities and actual labels to provide at least a minimum prediction accuracy, ranking loss to promote scoring of positive connections higher than negative connections to provide recommendation order and act as a regularizer, and diversity loss to penalize similar attention patterns across different heads to promote graph structure representation.

In Example 12, the subject matter of Example 11 includes, wherein training of the graph neural network uses positive examples, which are actual relationships between entities, and negative examples, which are generated at the predetermined ratio of negative to positive cases to learn correct relationships between monitors, metrics, and dimensions.

In Example 13, the subject matter of Examples 1-12 includes, wherein the metrics measure telemetry of network-based services monitored by the network-based service monitors that includes: at least one of: CPU usage, memory usage, disk input/output that indicates a rate of read and write operations, network traffic that indicates an amount of data being transmitted and received over a network, transaction rates that indicates a number of operations processed per unit time, and latency that indicates a time taken to process an operation, logs that contain records of events and activities that occur within the network-based service, including information about errors, warnings, informational messages, and user activities, traces that track flow of requests through various components of the network-based service, events that include specific occurrences or incidents that are significant for operation of the network-based service and include system failures, configuration changes, and security breaches, alerts that are generated based on predefined thresholds, and health indicators that provide a snapshot of overall health of the network-based service and that include uptime, error rates, and service availability.

In Example 14, the subject matter of Examples 1-13 includes, wherein: the configuration recommendation for the particular network-based service monitor depends on service dependencies that indicate relationships between different services in a cloud-based environment where one service relies on another to function correctly, the service dependencies include direct dependencies, indirect dependencies, and hierarchical dependencies, and the service dependencies involve service chaining, service mesh, redundancy and failover, service level agreements, and dependency mapping.

In Example 15, the subject matter of Examples 1-14 includes, wherein: service properties data for the network-based services monitored by the network-based service monitors are used to generate the input graph, the service properties data comprising service dependency data indicating dependencies among the network-based services, service reliability data that describes dependability of performance of the network-based services, and service-to-service similarity data indicating overlapping dependencies and usage patterns between the network-based services, and the service reliability data includes uptime, downtime, mean time between failures, mean time to repair, failure rate, error rate, response time, throughput, and redundancy and failover mechanisms.

In Example 16, the subject matter of Examples 1-15 includes, wherein the scoring mechanism evaluates the enriched node representations by analyzing historical performance data of the network-based services to identify patterns and trends that influence the configuration recommendations.

In Example 17, the subject matter of Examples 1-16 includes, wherein the attention-enhanced graph neural network is configured to generate explanations for the recommended monitor configurations.

In Example 18, the subject matter of Examples 1-17 includes, wherein the attention-enhanced graph neural network incorporates a feedback loop that allows users to provide feedback on the recommended configurations, the attention-enhanced graph neural network using the feedback to continuously improve performance.

In Example 19, the subject matter of Examples 1-18 includes, wherein the recommended monitor configuration is validated by simulating potential failure scenarios and assessing effectiveness of the recommended monitor configuration in detecting and responding to the potential failure scenarios.

In Example 20, the subject matter of Examples 1-19 includes, wherein: the network-based service monitors track performance and health of network-based services, the metrics measure telemetry of network-based services monitored by the network-based service monitors, and the dimensions comprise topological components defining levels at which the metrics are collected and stored.

Example 21 is a method for generating a monitor for a cloud-based service, the method comprising: determining that the monitor is to be generated for the cloud-based service; obtaining configurations from existing monitors of other cloud-based services; building similarity models using the configurations from the existing monitors, the similarity models configured to analyze and identify similarities between the cloud-based service and the other cloud-based services; and using a graph neural network to receive output from the similarity models and in response construct a configuration for the monitor for the cloud-based service, the graph neural network configured to use the similarities identified by the similarity models to create a graphical network that represents relationships between different attributes of the existing monitors and process the graphical network to generate configuration recommendations for the monitor.

In Example 22, the subject matter of Example 21 includes, wherein the graph neural network comprises: multi-head attention determiners configured to determine different aspects of node relationships within the graph neural network; edge-aware message transformers that determine specific relationship types among the node relationships; and a composite loss function configured to combine binary cross-entropy, ranking optimization, and diversity components within the graph neural network.

In Example 23, the subject matter of Example 22 includes, wherein: the multi-head attention determiners comprise multiple attention heads, each attention head is configured to: focus on different parts of data input to the graph neural network, compute attention scores independently, and combine the attention scores to form a final output, and for each attention head, attention weights are calculated to determine an importance of different neighboring nodes and relationships among the neighboring nodes, the attention weights used to aggregate information from the neighboring nodes for the graph neural network to focus on most relevant parts of the graph neural network.

In Example 24, the subject matter of Example 23 includes, wherein the different parts of input data include: metrics, which include time-series data that represent performance indicators of the cloud-based service, the time-series data including at least one of: CPU usage, memory usage, transaction rates, and latency; dimensions, which include topological components of the cloud-based service that define a level at which metrics are collected and stored, the topological components including at least one of data center location, environment, region, and compute node IDs, alert conditions, which include criteria and thresholds that determine when an alert should be triggered based on monitored metrics, the alert conditions including expressions used to evaluate the metrics and threshold values that, when breached, generate an alert, configuration settings, which define a manner in which the monitor operates including at least one of frequency of data collection, look-back period for aggregating metrics, severity of alerts, and aggregation methods, and relationships between attributes, which include connections and interactions between different attributes of the monitors, including an association between each monitor and its metrics, a connection between the metrics and dimensions for the monitor, and relationships between different monitors.

In Example 25, the subject matter of Example 24 includes, wherein: each attention head is configured to: calculate an attention score for each neighboring node by taking a dot product of a query vector (Q) and a key vector (K) of the neighboring node, the query vector representing a current node for which attention is being calculated, the key vector representing neighboring nodes to which the attention is being directed, a value vector representing features of the neighboring nodes, scale the attention score by the square root of a dimension of key vectors, normalize the attention scores using a softmax function, and compute a weighted sum of value vectors of the neighboring nodes using the normalized attention scores, the attention heads are configured to operate in parallel, concatenated output from the attention heads is passed through a linear transformation to combine the concatenated output, and the combined output is used for making predictions.

In Example 26, the subject matter of Examples 21-25 includes, wherein the graph neural network is configured to provide: ranked recommendations for dimensions to be used to aggregate metrics during creation of or configuration of the monitor, configuration recommendations for the monitor, and attention-weighted rankings that determine relative importance of different relationships between monitors, metrics, and dimensions in the monitor.

In Example 27, the subject matter of Example 26 includes, wherein the configuration recommendations for the monitor comprise: metrics to monitor, dimensions to be used for aggregation of the metrics, the dimensions being topological components of the cloud-based service that define a level at which the metrics are collected and stored, alert conditions and thresholds associated with the aggregation of the metrics to be used to generate alerts of the monitor, and configuration settings for the monitor.

In Example 28, the subject matter of Example 27 includes, wherein the dimensions represent indicators of the cloud-based service, which include success of an operation, file path, environment deployment of the cloud-based service, and identifier of a compute node.

In Example 29, the subject matter of Examples 27-28 includes, wherein the aggregation of the metrics uses a subset of all dimensions that emitted by the metrics.

In Example 30, the subject matter of Examples 21-29 includes, wherein the graph neural network includes: a training configuration uses message passing layers, hidden channels, output channels, an Adam optimizer with a predetermined learning rate and weight decay, a maximum number of epochs with early stopping, and a predetermined batch size, an edge set divided into a training set, a validation set, and a test set, in which: the training set includes edges used for message passing and fewer edges used for supervision, fixed negative edges are generated at a predetermined ratio for evaluation, and dynamic negate edges are generated during training using on-the-fly sampling, loss component functions that include: binary cross-entropy loss to provide at least a minimum prediction accuracy, tOP1−max ranking loss to provide recommendation order and act as a regularizer, and diversity loss to penalize similar attention patterns across different heads to promote graph structure representation, learning rate management that includes a learning rate scheduler and is configured to reduce a learning rate in response to determining that a validation loss fails to improve for a predetermined number of consecutive epochs, and uses an “E5” embedding model to generate feature embeddings for monitors and dimensions and captures semantic information from textual descriptions of metrics and dimensions.

In Example 31, the subject matter of Example 30 includes, wherein training of the graph neural network uses positive examples, which are actual relationships between entities, and negative examples, which are generated at the predetermined ratio of negative to positive cases to learn correct relationships between monitors, metrics, and dimensions.

In Example 32, the subject matter of Examples 21-31 includes, wherein data used to train the graph neural network uses a heterogeneous graph dataset representing a cloud monitoring system and includes structural information that provides relationships between entities and engagement information of a manner in which the entities interact.

In Example 33, the subject matter of Example 32 includes, wherein: the entities are node types that include monitors, metrics, and dimensions, the relationships are edge types that include monitor-to-dimension associations, metric-to-dimension connections, and monitor-to-metric connections, feature data in the heterogeneous graph dataset includes monitor features that include embeddings of metric names associated with each monitor, dimension features that include embeddings of dimension names, and text features generated using an “E5” embedding model to capture semantic information, and node attributes in the heterogeneous graph dataset includes intrinsic features that contain domain-specific attributes and learned embeddings that are trainable and capture a role of an entity role in a structure of the graph neural network.

Example 34 is at least one machine-readable medium including instructions that, when executed by processing circuitry, cause the processing circuitry to perform operations to implement of any of Examples 1-33.

Example 35 is an apparatus comprising means to implement of any of Examples 1-33.

Example 36 is a system to implement of any of Examples 1-33.

Example 37 is a method to implement of any of Examples 1-33.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system for configuring network-based service monitors, comprising:
a processor; and
a memory storing instructions that, when executed by the processor, cause the system to:
identify an input graph comprising:
nodes representing network-based service monitors that continuously analyze telemetry emitted by network-based services to detect anomalies and create alerts and warnings based thereon, metrics that identify which performance indicators should be tracked, and dimensions that are used for aggregation of the metrics and that define metric collection levels of the network-based services at which the metrics are collected and stored, and
edges indicating associations between the network-based service monitors and the dimensions, connections between the metrics and the dimensions, and relationships between the network-based service monitors and the metrics;
generate a recommended monitor configuration for a particular network-based service by processing the input graph through an attention-enhanced graph neural network trained using existing monitor-to-dimension associations, metric-to-dimension connections, and monitor-to-metric connections from other network-based service monitors;
process, using a graph neural network of the attention-enhanced graph neural network, the input graph to produce enriched node representations for each node of the input graph, the enriched node representation for each node incorporating information from neighbors of the node and an overall structure of the input graph;
evaluate, using a scoring mechanism of the attention-enhanced graph neural network, the enriched node representations by analyzing monitor and service similarities, weighting relationships according to shared characteristics and dependencies, and applying trained attention weights to generate predicted probability scores for potential configuration relationships indicating a likelihood of valid and effective configurations;
evaluate, using a link prediction component of the attention-enhanced graph neural network, the predicted probability scores against known configuration patterns to determine a likelihood of valid configuration relationships to generate the recommended monitor configuration based on probability relationships among the valid configuration relationships; and
configure a network-based service monitor for the particular network-based service based on the recommended monitor configuration.

2. The system of claim 1, wherein the recommended monitor configuration comprises:
metrics to monitor for the particular network-based service,
dimensions for the particular network-based service,
alert conditions and thresholds associated with the aggregation of the metrics for the particular network-based service that specify criteria and thresholds for triggering alerts based on the monitored metrics, and
configuration settings for the network-based service monitor that define a manner in which the network-based service monitor operates, including a frequency of data collection, look-back period, severity of alerts, and aggregation methods.

3. The system of claim 1, wherein the attention-enhanced graph neural network further comprises attention-weighted rankings that determine relative importance of different relationships between the network-based service monitors, metrics, and dimensions to prioritize potential configurations for the network-based service monitor.

4. The system of claim 1, wherein:
the instructions, when executed by the processor, cause the system to:
receive network-based service monitor data of the network-based service monitors that comprises the metrics, dimensions, and monitor configurations; and
receive service properties data for the network-based services monitored by the network-based service monitors, the service properties data comprising service dependency data indicating dependencies among the network-based services, service reliability data that describes dependability of performance of the network-based services, and service-to-service similarity data indicating overlapping dependencies and usage patterns between the network-based services; and
identifying the input graph comprises creating the input graph from network-based service monitor data and service properties data.

5. The system of claim 1, wherein the graph neural network comprises:
multi-head attention determiners configured to determine different aspects of node relationships within the graph neural network;
edge-aware message transformers that determine specific relationship types among the node relationships; and
a composite loss function configured to combine binary cross-entropy, ranking optimization, and diversity components within the graph neural network.

6. The system of claim 5, wherein:
the multi-head attention determiners comprise multiple attention heads,
each attention head is configured to:
focus on different parts of data input to the graph neural network,
compute attention scores independently, and
combine the attention scores to form a final output, and
for each attention head, attention weights are calculated to determine an importance of different neighboring nodes and relationships among the neighboring nodes, the attention weights used to aggregate information from the neighboring nodes for the graph neural network to focus on most relevant parts of the graph neural network.

7. The system of claim 6, wherein the different parts of input data include:
time-series data of the metrics, the time-series data representing performance indicators of a cloud-based service, the time-series data including at least one of: CPU usage, memory usage, disk input/output, network traffic, transaction rates, and latency;
the dimensions, which include at least one of data center location, environment, region, and compute node IDs,
alert conditions, which include criteria and thresholds that determine when an alert should be triggered based on monitored metrics, the alert conditions including expressions used to evaluate the metrics and threshold values that, when breached, generate an alert,
configuration settings, which define a manner in which the network-based service monitor operates including at least one of frequency of data collection, look-back period for aggregating metrics, severity of alerts, and aggregation methods, and
relationships between attributes, which include connections and interactions between different attributes of the network-based service monitors, including an association between each network-based service monitor and its metrics, a connection between the metrics and dimensions for the network-based service monitor, and relationships between different monitors.

8. The system of claim 7, wherein:
each attention head is configured to:
calculate an attention score for each neighboring node by taking a dot product of a query vector (Q) and a key vector (K) of the neighboring node, the query vector representing a current node for which attention is being calculated, the key vector representing neighboring nodes to which the attention is being directed, a value vector representing features of the neighboring nodes,
scale the attention score by the square root of a dimension of key vectors,
normalize the attention scores using a softmax function, and
compute a weighted sum of value vectors of the neighboring nodes using the normalized attention scores,
the attention heads are configured to operate in parallel,
concatenated output from the attention heads is passed through a linear transformation to combine the concatenated output, and
the combined output is used for making predictions.

9. The system of claim 1, wherein the dimensions represent indicators of a cloud-based services that include success of an operation, file path, environment deployment of the cloud-based services, and identifier of a compute node.

10. The system of claim 1, wherein aggregation of the metrics uses a subset of all dimensions that emitted by the metrics.

11. The system of claim 1, wherein the graph neural network includes:
a training configuration that uses message passing layers, hidden and output channels, an Adam optimizer with a predetermined learning rate and weight decay, a learning rate scheduler configured to reduce a learning rate in response to determining that a validation loss fails to improve for a predetermined number of consecutive epochs, a maximum number of epochs with early stopping to halt training if the validation loss does not improve for a specified number of epochs, and a predetermined batch size, and
an edge set divided into a training set, a validation set, and a test set, in which:
the training set includes edges used for message passing and fewer edges used for supervision,
fixed negative edges are generated at a predetermined ratio for evaluation, and
dynamic negate edges are generated during training using on-the-fly sampling, and
loss component functions include:
binary cross-entropy loss that measures a difference between predicted probabilities and actual labels to provide at least a minimum prediction accuracy,
ranking loss to promote scoring of positive connections higher than negative connections to provide recommendation order and act as a regularizer, and
diversity loss to penalize similar attention patterns across different heads to promote graph structure representation.

12. The system of claim 11, wherein training of the graph neural network uses positive examples, which are actual relationships between entities, and negative examples, which are generated at the predetermined ratio of negative to positive cases to learn correct relationships between monitors, metrics, and dimensions.

13. The system of claim 1, wherein the metrics measure telemetry of network-based services monitored by the network-based service monitors that includes:
at least one of: CPU usage, memory usage, disk input/output that indicates a rate of read and write operations, network traffic that indicates an amount of data being transmitted and received over a network, transaction rates that indicates a number of operations processed per unit time, and latency that indicates a time taken to process an operation,
logs that contain records of events and activities that occur within the network-based service, including information about errors, warnings, informational messages, and user activities,
traces that track flow of requests through various components of the network-based service,
events that include specific occurrences or incidents that are significant for operation of the network-based service and include system failures, configuration changes, and security breaches,
alerts that are generated based on predefined thresholds, and
health indicators that provide a snapshot of overall health of the network-based service and that include uptime, error rates, and service availability.

14. The system of claim 1, wherein:
the configuration recommendation for the particular network-based service monitor depends on service dependencies that indicate relationships between different services in a cloud-based environment where one service relies on another to function correctly,
the service dependencies include direct dependencies, indirect dependencies, and hierarchical dependencies, and
the service dependencies involve service chaining, service mesh, redundancy and failover, service level agreements, and dependency mapping.

15. The system of claim 1, wherein:
service properties data for the network-based services monitored by the network-based service monitors are used to generate the input graph, the service properties data comprising service dependency data indicating dependencies among the network-based services, service reliability data that describes dependability of performance of the network-based services, and service-to-service similarity data indicating overlapping dependencies and usage patterns between the network-based services, and
the service reliability data includes uptime, downtime, mean time between failures, mean time to repair, failure rate, error rate, response time, throughput, and redundancy and failover mechanisms.

16. The system of claim 1, wherein the scoring mechanism evaluates the enriched node representations by analyzing historical performance data of the network-based services to identify patterns and trends that influence the configuration recommendations.

17. The system of claim 1, wherein the attention-enhanced graph neural network is configured to generate explanations for the recommended monitor configurations.

18. The system of claim 1, wherein:
the attention-enhanced graph neural network incorporates a feedback loop that allows users to provide feedback on the recommended configurations, the attention-enhanced graph neural network using the feedback to continuously improve performance, and
the recommended monitor configuration is validated by simulating potential failure scenarios and assessing effectiveness of the recommended monitor configuration in detecting and responding to the potential failure scenarios.

19. A method for generating a monitor for a cloud-based service, the method comprising:
determining that the monitor is to be generated for the cloud-based service;
obtaining configurations from existing monitors of other cloud-based services;
building similarity models using the configurations from the existing monitors, the similarity models configured to analyze and identify similarities between the cloud-based service and the other cloud-based services; and
using a graph neural network to receive output from the similarity models and in response construct a configuration for the monitor for the cloud-based service, the graph neural network configured to use the similarities identified by the similarity models to create a graphical network that represents relationships between different attributes of the existing monitors and process the graphical network to generate configuration recommendations for the monitor.

20. The method of claim 19, wherein:
the graph neural network comprises:
multi-head attention determiners having multiple attention heads configured to operate in parallel and configured to determine different aspects of node relationships within the graph neural network;
edge-aware message transformers that determine specific relationship types among the node relationships; and
a composite loss function configured to combine binary cross-entropy, ranking optimization, and diversity components within the graph neural network, each attention head is configured to:
focus on different parts of data input to the graph neural network,
compute attention scores independently,
combine the attention scores to form a final output,
calculate an attention score for each neighboring node by taking a dot product of a query vector (Q) and a key vector (K) of the neighboring node, the query vector representing a current node for which attention is being calculated, the key vector representing neighboring nodes to which the attention is being directed, a value vector representing features of the neighboring nodes,
scale the attention score by the square root of a dimension of key vectors,
normalize the attention scores using a softmax function, and
compute a weighted sum of value vectors of the neighboring nodes using the normalized attention scores,
concatenated output from the attention heads is passed through a linear transformation to combine the concatenated output, and
the combined output is used for making predictions.
